(19) United States
(12) Patent Application Publication
(10) Pub. No.: US 2004/0093997 A1
(43) Pub. Date: May 20, 2004

(54) Tool extension with a screw attraction structure

(76) Inventor: Li Shiu Huang, Taichuang (TW)

Correspondence Address: Li Shiu Huang, P.O. Box 65-45, Taichuang, 403, TW

(21) Appl. No.: 10/294,795

(22) Filed: Nov. 15, 2002

(51) Int. Cl. B25B 13/02

(52) U.S. Cl. 81/125

(57) ABSTRACT

A tool extension with a screw attraction structure includes an extension rod, an adjusting sleeve, a retaining ring, and a magnetic member. Thus, the screw may be attracted by the magnetic member in the extension rod, so that the extension rod may be used to rotate and lock the screw automatically without having to hold the screw manually, thereby facilitating the user operating the screw, and thereby enhancing the safety of usage. In addition, the limit of movement of the screwdriver head and the locking limit of the screw may be determined by adjusting the relative position between the adjusting sleeve and the mounting head of the extension rod.

### BACKGROUND OF THE INVENTION

1. Field of the Invention

The present invention relates to a tool extension with a screw attraction structure, and more particularly to a tool extension with a screw attraction structure, wherein the screw may be attracted by the magnetic member in the extension rod, so that the extension rod may be used to rotate and lock the screw automatically without having to hold the screw manually, thereby facilitating the user operating the screw, and thereby enhancing the safety of usage.

2. Description of the Related Art

A conventional tool extension in accordance with the prior art shown in FIGS. 1 and 2 comprises an extension rod 10 provided with a mounting head 11 formed with an outer threaded portion 12, a retractable sleeve 13 mounted on the extension rod 10, a retaining ring 14 screwed on the outer threaded portion 12 of the extension rod 10, an urging ring 15 screwed on the outer threaded portion 12 of the extension rod 10, a snap ring 16 mounted on the mounting head 11 of the extension rod 10, and a spring 17 mounted on the extension rod 10 and urged between the snap ring 16 and an inner edge of the retractable sleeve 13. The retaining ring 14 may be rotated on the outer threaded portion 12 of the extension rod 10 to adjust the compressible extent of the retractable sleeve 13. Thus, when the extension rod 10 is driven by a motorized or pneumatic tool to rotate and lock a screw, the retaining ring 14 may be used to retain the retractable sleeve 13, so as to set the rotation limit of the screw, so that the screw may be locked to a predetermined depth at a time. However, the user has to hold the screw manually, thereby causing inconvenience and difficulty in operation.

### SUMMARY OF THE INVENTION

The present invention has arisen to mitigate and/or obviate the disadvantage of the conventional tool extension.

The primary objective of the present invention is to provide a tool extension with a screw attraction structure, wherein the screw may be attracted by the magnetic member in the extension rod, so that the extension rod may be used to rotate and lock the screw automatically without having to hold the screw manually, thereby facilitating the user operating the screw, and thereby enhancing the safety of usage.

Another objective of the present invention is to provide a tool extension with a screw attraction structure, wherein the limit of movement of the screwdriver head and the locking limit of the screw may be determined by adjusting the relative position between the adjusting sleeve and the mounting head of the extension rod.

In accordance with the present invention, there is provided a tool extension with a screw attraction structure, comprising an extension rod, an adjusting sleeve, a retaining ring, and a magnetic member, wherein:

the extension rod has a first end provided with a hexagonal drive head and a second end provided with a mounting head, the mounting head of the extension rod has an outer wall formed with an outer threaded section;

the retaining ring is screwed on the outer threaded section of the outer wall of the mounting head of the extension rod;

the adjusting sleeve is mounted on the outer wall of the mounting head of the extension rod, and is rested on the retaining ring, the adjusting sleeve has a first end having an inner edge formed with an inner threaded section screwed on the outer threaded section of the outer wall of the mounting head of the extension rod,

the magnetic member is mounted in a second end of the adjusting sleeve.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a conventional tool extension in accordance with the prior art;

FIG. 2 is a side plan cross-sectional assembly view of the conventional tool extension as shown in FIG. 1;

FIG. 3 is an exploded perspective view of a tool extension with a screw attraction structure in accordance with a preferred embodiment of the present invention;

FIG. 4 is a side plan cross-sectional assembly view of the tool extension with a screw attraction structure as shown in FIG. 3;

FIG. 5 is a schematic operational view of the tool extension with a screw attraction structure as shown in FIG. 4 in use;

FIG. 6 is an exploded perspective view of a tool extension with a screw attraction structure in accordance with another embodiment of the present invention; and

FIG. 7 is a side plan cross-sectional assembly view of the tool extension with a screw attraction structure as shown in FIG. 6.

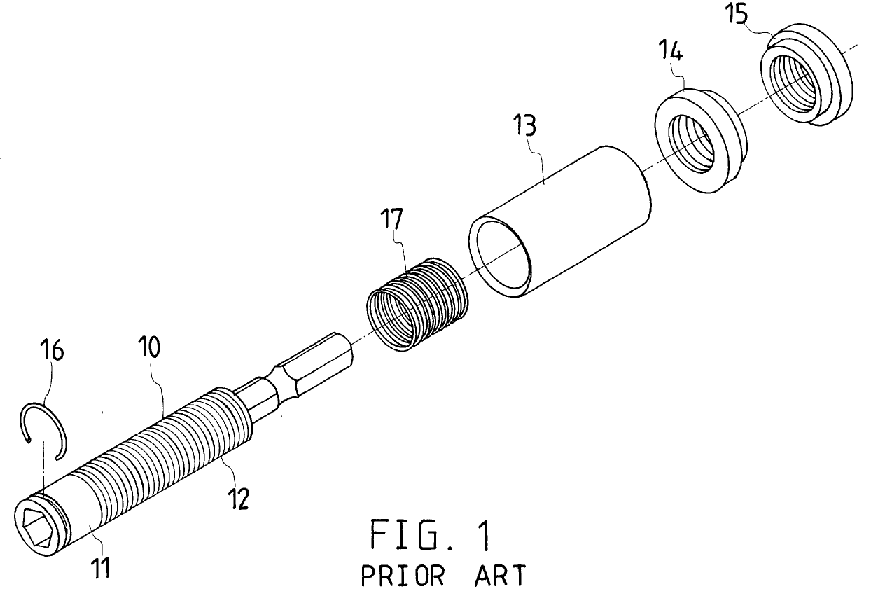

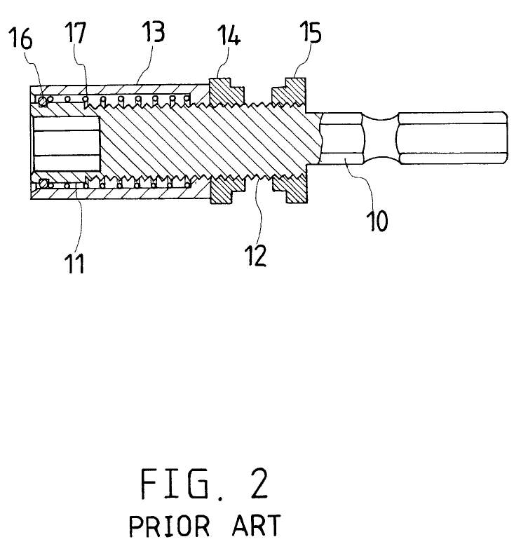

### DETAILED DESCRIPTION OF THE INVENTION

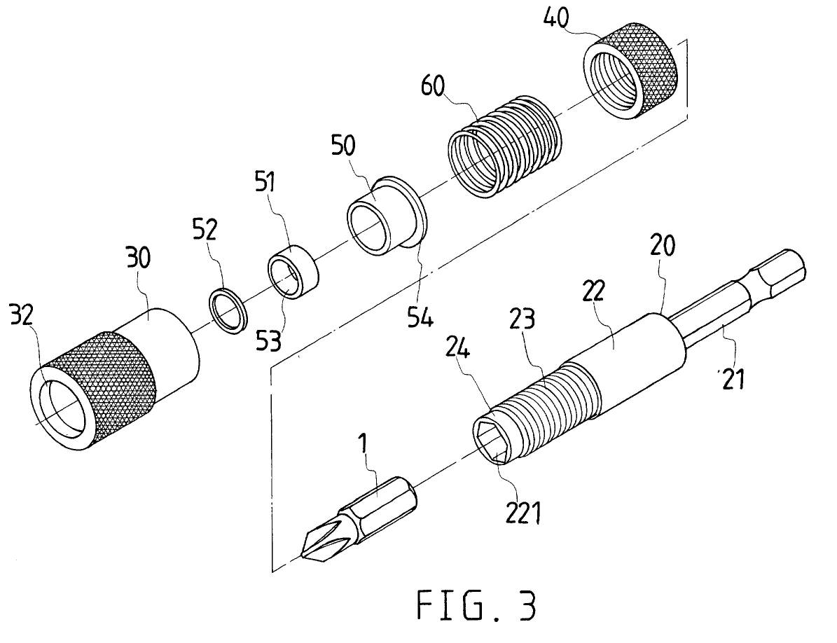

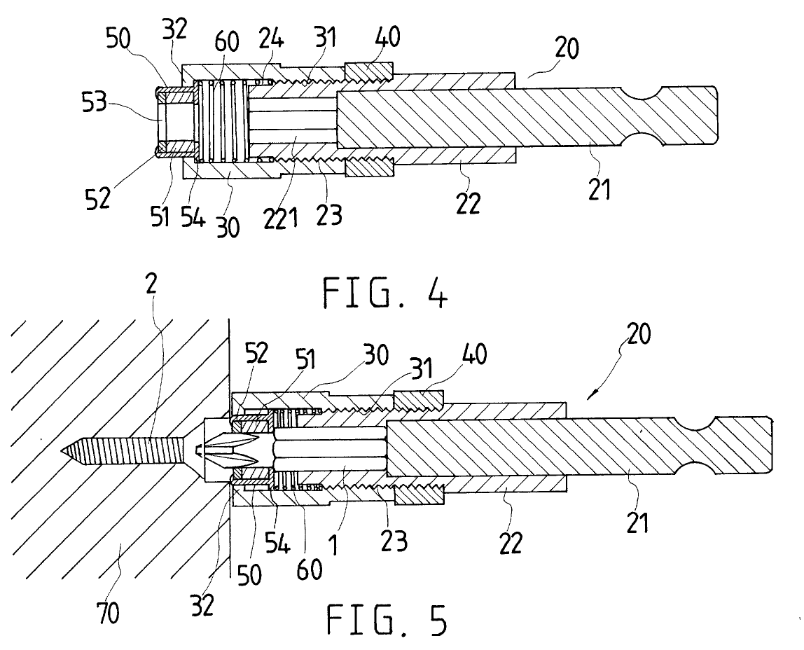

Referring to the drawings and initially to FIGS. 3-5, a tool extension with a screw attraction structure in accordance with a preferred embodiment of the present invention comprises an extension rod 20, an adjusting sleeve 30, and a retaining ring 40.

The extension rod 20 has a first end provided with a hexagonal drive head 21 and a second end provided with a mounting head 22. The drive head 21 of the extension rod 20 is mounted in a motorized or pneumatic tool, so that the extension rod 20 may be driven to rotate by the motorized or pneumatic tool. The mounting head 22 of the extension rod 20 has an outer wall formed with an outer threaded section 23 and an inner wall formed with a hexagonal recess 221. A screwdriver head 1 may be inserted into the hexagonal recess 221 of the mounting head 22 of the extension rod 20. The outer wall of the mounting head 22 of the extension rod 20 has a front end provided with a reduced diameter section 24.

The retaining ring 40 is screwed on the outer threaded section 23 of the outer wall of the mounting head 22 of the extension rod 20.

The adjusting sleeve 30 is mounted on the outer wall of the mounting head 22 of the extension rod 20, and is rested on the retaining ring 40. The adjusting sleeve 30 has a first end having an inner edge formed with an inner threaded section 31 screwed on the outer threaded section 23 of the outer wall of the mounting head 22 of the extension rod 20, and a second end having an inner edge formed with a catch ring 32. Thus, the adjusting sleeve 30 may be rotated on the mounting head 22 of the extension rod 20 so as to adjust the relative position between the adjusting sleeve 30 and the extension rod 20 arbitrarily.

After the adjusting sleeve 30 is rotated and adjusted on the mounting head 22 of the extension rod 20 to a predetermined position, the retaining ring 40 may be rotated on the outer threaded section 23 of the outer wall of the mounting head 22 of the extension rod 20 to urge and retain the first end of the adjusting sleeve 30, thereby maintaining the relative position between the adjusting sleeve 30 and the mounting head 22 of the extension rod 20, and thereby maintaining the relative position between the adjusting sleeve 30 and the screwdriver head 1 in the hexagonal recess 221 of the mounting head 22 of the extension rod 20.

In operation, when the extension rod 20 is driven to rotate by the motorized or pneumatic tool, the screwdriver head 1 is rotated by the extension rod 20 to rotate and lock a screw 2 into a workpiece 70 as shown in FIG. 5. At the same time, the adjusting sleeve 30 is also rotated by the extension rod 20. Thus, when the second end of the adjusting sleeve 30 contacts the surface of the workpiece 70, the screwdriver head 1 cannot be further screwed into the workpiece 70 any more, thereby preventing a further movement of the screwdriver head 1. In such a manner, the limit of movement of the screwdriver head 1 may be determined by adjusting the relative position between the adjusting sleeve 30 and the mounting head 22 of the extension rod 20.

The tool extension with a screw attraction structure in accordance with the preferred embodiment of the present invention further comprises an annular seat 50, a magnetic member 51, a washer 52, and a spring 60.

The annular seat 50 is mounted in the adjusting sleeve 30, and has a rear end having an outer edge formed with an annular catch flange 54 that may be rested on the catch ring 32 of the adjusting sleeve 30, thereby preventing the annular seat 50 from detaching from the adjusting sleeve 30.

The magnetic member 51 and the washer 52 are mounted in the annular seat 50. The magnetic member 51 is formed with a through hole 53 for passage of the screwdriver head 1. Thus, the screw 2 may be attracted by the magnetic member 51 in the annular seat 50, thereby facilitating the screwdriver head 1 operating the screw 2.

The spring 60 is mounted on the mounting head 22 of the extension rod 20, and is pressed between the reduced diameter section 24 of the outer wall of the mounting head 22 of the extension rod 20 and the annular seat 50. Thus, the annular seat 50 is normally pressed by the spring 60 to protrude outward from the catch ring 32 of the adjusting sleeve 30.

In practice, the screwdriver head 1 is inserted into the hexagonal recess 221 of the mounting head 22 of the extension rod 20. Then, the adjusting sleeve 30 is rotated on the mounting head 22 of the extension rod 20 to adjust the relative position between the adjusting sleeve 30 and the mounting head 22 of the extension rod 20. Then, the screw 2 is attracted by the magnetic member 51 in the annular seat 50. Then, the screwdriver head 1 may be pushed to pass through the through hole 53 of the magnetic member 51, and the annular seat 50 pressed to retract into the catch ring 32 of the adjusting sleeve 30, so that the screwdriver head 1 may be inserted into the screw 2. Thus, when the extension rod 20 is driven to rotate by the motorized or pneumatic tool, the screwdriver head 1 is rotated by the extension rod 20 to rotate and lock the screw 2 into the workpiece 70 as shown in FIG. 5. In such a manner, the extension rod 20 may be used to rotate and lock the screw 2 automatically, without having to hold the screw 2 manually, thereby facilitating the user operating the screw 2, and thereby enhancing the safety of usage.

In addition, when the second end of the adjusting sleeve 30 contacts the surface of the workpiece 70, the screwdriver head 1 cannot be further screwed into the workpiece 70 any more, thereby preventing a further movement of the screwdriver head 1. In such a manner, the limit of movement of the screwdriver head 1 may be determined by adjusting the relative position between the adjusting sleeve 30 and the mounting head 22 of the extension rod 20.

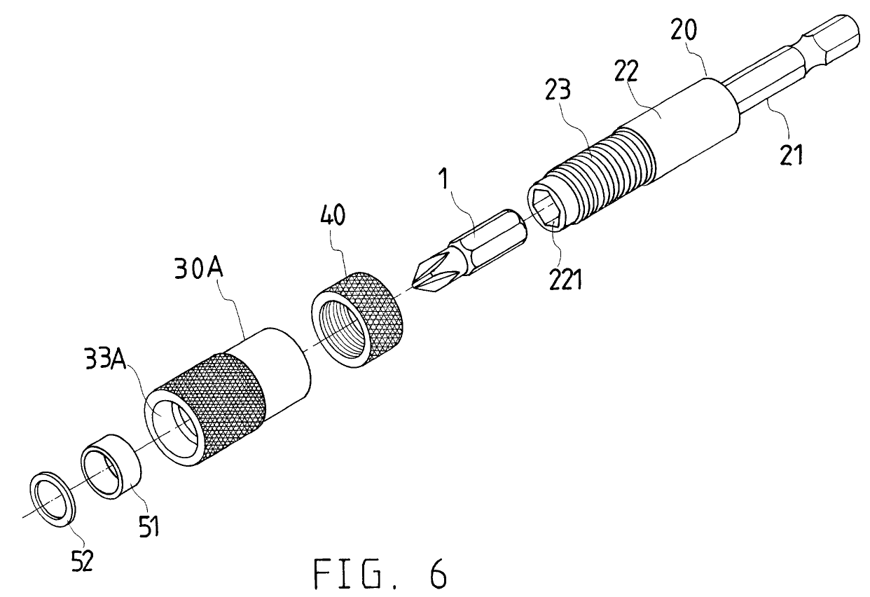

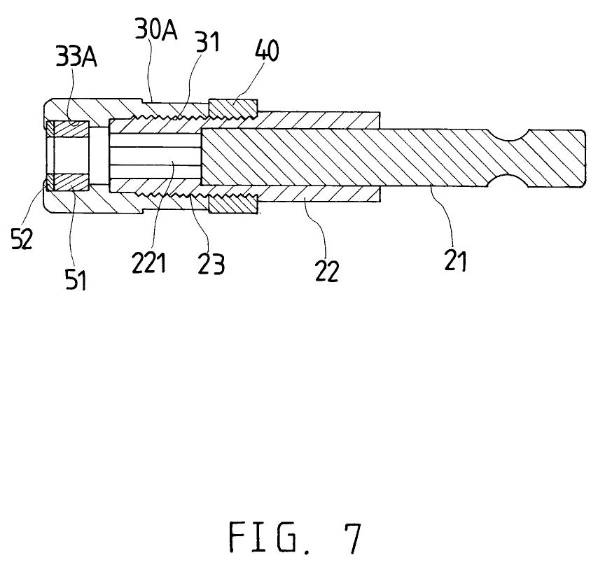

Referring to FIGS. 6 and 7, a tool extension with a screw attraction structure in accordance with another embodiment of the present invention is shown. In practice, the adjusting sleeve 30A has a second end formed with a receiving chamber 33A, so that the magnetic member 51 and the washer 52 are directly embedded in the receiving chamber 33A of the adjusting sleeve 30A. Thus, the screw 2 may be attracted by the magnetic member 51 in the receiving chamber 33A of the adjusting sleeve 30A.

While the preferred embodiment of the present invention has been shown and described, it will be apparent to those skilled in the art that various modifications may be made in the embodiment without departing from the spirit of the present invention. Such modifications are all within the scope of the present invention.

What is claimed is:

1. A tool extension with a screw attraction structure, comprising an extension rod, an adjusting sleeve, a retaining ring, and a magnetic member, wherein:
the extension rod has a first end provided with a hexagonal drive head and a second end provided with a mounting head, the mounting head of the extension rod has an outer wall formed with an outer threaded section;
the retaining ring is screwed on the outer threaded section of the outer wall of the mounting head of the extension rod;
the adjusting sleeve is mounted on the outer wall of the mounting head of the extension rod, and is rested on the retaining ring, the adjusting sleeve has a first end having an inner edge formed with an inner threaded section screwed on the outer threaded section of the outer wall of the mounting head of the extension rod,
the magnetic member is mounted in a second end of the adjusting sleeve.

2. The tool extension with a screw attraction structure in accordance with claim 1, wherein the mounting head of the extension rod has an inner wall formed with a hexagonal recess.

3. The tool extension with a screw attraction structure in accordance with claim 1, further comprising an annular seat mounted in the adjusting sleeve for receiving the magnetic member therein.

4. The tool extension with a screw attraction structure in accordance with claim 3, wherein the second end of the adjusting sleeve has an inner edge formed with a catch ring, and the annular seat has a rear end having an outer edge formed with an annular catch flange that is rested on the catch ring of the adjusting sleeve, thereby preventing the annular seat from detaching from the adjusting sleeve.

5. The tool extension with a screw attraction structure in accordance with claim 3, further comprising a washer mounted in the annular seat and urged on the magnetic member.

6. The tool extension with a screw attraction structure in accordance with claim 3, wherein the outer wall of the mounting head of the extension rod has a front end provided with a reduced diameter section, and the tool extension further comprises a spring mounted on the mounting head of the extension rod and pressed between the reduced diameter section of the outer wall of the mounting head of the extension rod and the annular seat.

7. The tool extension with a screw attraction structure in accordance with claim 1, wherein the magnetic member is formed with a through hole for passage of a screwdriver head.

8. The tool extension with a screw attraction structure in accordance with claim 1, wherein the second end of the adjusting sleeve is formed with a receiving chamber, so that the magnetic member is embedded in the receiving chamber of the adjusting sleeve.
